(19) United States
(12) Patent Application Publication
(10) Pub. No.: US 2017/0216841 A1
(43) Pub. Date: Aug. 3, 2017

(54) MODULAR MICROFLUIDIC DEVICE

(71) Applicant: Cambsolv Limited, Cambridge (GB)

(72) Inventors: Hugh Malkin, Cottenham (GB); Nicholas James Hastings, Cambridge (GB); Graham Scott Gutsell, Cambridge (GB); Ian Morgan George, Cottenham (GB)

(73) Assignee: Cambsolv Limited, Cambridge (GB)

(21) Appl. No.: 15/427,791

(22) Filed: Feb. 8, 2017

Related U.S. Application Data
(63) Continuation of application No. PCT/GB2015/005233, filed on Aug. 12, 2015.

(51) Int. Cl. B01L 3/00; G01N 1/38

(52) U.S. Cl. CPC B01L 3/502715; B01L 3/527; G01N 1/38; B01L 2200/16; B01L 2200/0631; B01L 2300/0861; B01L 2300/0627; B01L 2300/0867; B01L 2400/0644; B01L 2200/028; B01L 2200/027

(57) ABSTRACT

Described is a modular microfluidic device (MMD) for producing an analyte composition from a biological fluid sample, said device comprising: (a) a reagent module (RM) comprising a reagent reservoir containing a reagent and an eluent reservoir containing an eluent, said reagent and eluent reservoirs being coupled to one or more RM microchannels; and (b) a sample preparation module (SPM) comprising a SPM microchannel adapted to couple with the RM microchannel whereby fluid continuity between SPM and RM microchannels is produced on coupling, and: (i) a sample inlet for receiving said biological fluid sample; (ii) an outlet for delivering said analyte composition; (iii) a mixing chamber; (v) a metering chamber; (vi) an eluent chamber; (vii) a valve; (viii) a solid phase extraction element (SPE); and (ix) an aspirator in fluid communication with the sample inlet of the SPM for withdrawing an aliquot of said biological fluid when contained in a sample vessel, said aspirator being operably coupled to a pneumatic fluid level sensor.

### FIELD OF THE INVENTION

The invention relates to a modular microfluidic device for producing an analyte composition from a biological fluid sample. The device comprises a reagent module comprising a reagent reservoir containing a reagent and an eluent reservoir containing an eluent and a sample preparation module comprising a solid phase extraction element. The invention also relates to methods and processes for preparing and/or analysing analyte compositions prepared using the microfluidic device of the invention.

### BACKGROUND TO THE INVENTION

Numerous tests, particularly diagnostic tests, are currently carried out on samples of biological fluids. Typically, an analyte present in the sample (or generated therein using various reagents) is analysed (directly or indirectly via the analysis of a biochemical marker which serves as a surrogate for the analyte itself) and its presence and/or quantity used to diagnose or prognose disease or injury, to determine nutritional or toxicological status, the response to therapeutic interventions or diet, to detect drug consumption, and to detect or monitor disease progression, pregnancy or fertility.

Such tests are routinely carried out on various biological fluids which can be easily obtained from a subject, including whole blood, serum, plasma, urine, sputum, sweat, follicular fluid, synovial fluid, amniotic fluid, nasopharyngeal aspirates, bronchial aspirates, semen and cerebrospinal fluid.

Current methods for analysing such biological fluids are currently comprised of at least three distinct stages: sample collection (typically carried out by nursing staff using aseptic techniques), a preliminary sample preparation stage in which the target analyte is generated and/or made available from the sample for subsequent analysis and a final analytical step in which the presence and/or quantity of the analyte is determined.

While the final analytical step may be carried out using automated, high-throughput analytical devices (such as LC-MS devices), the sample preparation stage often requires many manual operations and the skilled use of various laboratory reagents, equipment and devices. To perform a sample preparation according to a predetermined, validated, protocol (which is typically essential in the healthcare fields), many highly skilled and trained technicians repeatedly perform various processes including loading of a reagent, mixing, isolating and transporting, extracting, reacting and centrifuging.

Such labour intensive processes are slow, expensive and may result in erroneous results due to human error. There is therefore a growing need for rapid, cost-efficient and reliable biological fluid sample preparation methods.

Microfluidic devices have been developed which attempt to address the problems highlighted above. Microfluidic devices are designed to handle very small volumes of liquid (microlitre range or less), generally in the context of small (i.e. easily portable) and disposable cartridges (“chips” or “biochips”) which contain a microfluidic system of interconnecting reservoirs, chambers, cavities and channels (“microchannels”) as well as a number of components which serve as miniaturized laboratory instruments (including on-chip chromatography columns, filters, valves, mixing chambers, sensors, pumps and detectors). Such cartridges are often referred to as a “lab-on-a-chip” (or LOC).

However, the tiny fluid handling capacities and limited range of on-chip functionality available with any given LOC has limited the application of microfluidic technology to biological fluid sample preparation. In particular, there is a need for LOCs which can be loaded with sample directly from a primary biological fluid sample (such as whole blood), and for LOCs which are sufficiently flexible as to be suitable for the preparation of a range of different analytes from a number of different types of biological sample.

However, the loading of LOCs directly from primary biological fluid samples is complicated by the fact that, due to the biohazardous nature of many biological fluids, the samples may be contained in sealed vessels (for example, in a capped Vacutainer®). In such cases, the seal may take the form of a rubber septum which must be pierced by an aspirator in order to recover an aliquot of the sample.

Moreover, primary biological fluid samples are typically collected and/or stored in vessels which may be rendered opaque by applied labels (for example barcodes), which are needed for inter alia patient data. Finally, clinical sampling is complicated by patient variability, and so the quantity and quality of the biological fluid sample may be highly variable.

In such circumstances, manual loading of the LOC is complicated by the fact that visual inspection of the sample (and in particular of the fluid surface level) is difficult or impossible, while the need for seal piercing/aspiration via needle-type cannulas involves significant needlestick injury risk, both during the sample aspiration step and the sample loading step.

It is therefore highly desirable to automate direct loading of LOCs with samples from a primary biological fluid vessel.

The present invention provides a modular microfluidic device for producing an analyte composition from a biological fluid sample which permits safe, reliable and automated loading of a biological fluid sample directly from a primary biological sample and which is sufficiently flexible as to be suitable for the preparation of a range of different analytes from a number of different types of biological sample.

### SUMMARY OF THE INVENTION

In a first aspect there is provided a modular microfluidic device (MMD) for producing an analyte composition from a biological fluid sample, said device comprising:
(a) a reagent module (RM) comprising a reagent reservoir containing a reagent and an eluent reservoir containing an eluent, said reagent and eluent reservoirs being coupled to one or more RM microchannels; and
(b) a sample preparation module (SPM) comprising a SPM microchannel adapted to couple with the RM microchannel whereby fluid continuity between SPM and RM microchannels is produced on coupling, and:
   (i) a sample inlet for receiving said biological fluid sample;
   (ii) an outlet for delivering said analyte composition;
   (iii) a mixing chamber;
   (v) a metering chamber;
   (vi) an eluent chamber;
   (vii) a valve;
   (viii) a solid phase extraction element (SPE); and
   (ix) an aspirator in fluid communication with the sample inlet of the SPM for withdrawing an aliquot of said biological fluid when contained in a sample vessel, said aspirator being operably coupled to a pneumatic fluid level sensor.

In another aspect there is provided a modular microfluidic device (MMD) for producing an analyte composition from a biological fluid sample, said device comprising:
(a) a reagent module (RM) comprising a reagent reservoir containing a reagent and an eluent reservoir containing an eluent, said reagent and eluent reservoirs being coupled to one or more RM microchannels; and
(b) a sample preparation module (SPM) comprising a SPM microchannel adapted to couple with the RM microchannel whereby fluid continuity between SPM and RM microchannels is produced on coupling, and:
   (i) a sample inlet for receiving said biological fluid sample; (ii) an outlet for delivering said analyte composition; (iii) a pressure sensor component; (iv) a mixing chamber; (v) a metering chamber; (vi) an eluent chamber; (vii) a valve; and (viii) a solid phase extraction element (SPE); and.
(c) a processing head, said processing head comprising:
   (i) a pump adapted to couple with an MMD microchannel for driving or aspirating fluid through said microchannel, said processing head pump being further adapted to couple with the sample inlet of the SPM for drawing a liquid aliquot from a primary biological sample contained in a sample vessel; and
   (ii) a sensor component adapted to form a pressure sensor in conjunction with the SPM pressure sensor component;
      wherein the sample inlet of the SPM is coupled to an aspirator for drawing a liquid aliquot from a biological sample contained in a sample vessel.

The modular nature of the microfluidic device of the invention provides great flexibility, and facilitates the analysis of different analytes from different biological samples using a single universal SPM in conjunction with various analyte-specific RMs selected according to the analyte to be prepared.

The aspirator may be suitable for drawing a liquid aliquot from a primary biological sample contained in a sample vessel, such as a (capped or non-capped) Vacutainer®.

The SPM and aspirator may be integrated to form an autosampler which is manipulated robotically. In such embodiments, the SPM-aspirator autosampler may take the form of a disposable unit.

In another embodiment, the SPM further comprises one or more filter(s).

The SPE may be reversibly and selectively connectable to a plurality of microchannels via a plurality of ports. Thus, the SPE may comprise ports for reversible and selective fluid communication with: (a) a microchannel for delivering a drying gas, for example air, to the SPE; and/or (b) the mixing chamber of the SPM; and/or (c) the eluent reservoir of the RM; and/or (d) the eluent chamber of the SPM.

In another aspect, the invention provides a coupled modular microfluidic device (CMMD) for producing an analyte composition from a biological fluid sample, said device comprising an RM as defined herein coupled to an SPM as defined herein such that RM and SPM microchannels are in fluid communication.

In a related aspect, the invention also provides a microfluidic device wherein the RM and SPM together constitute a unitary, non-modular microfluidic device, being integrated such that RM and SPM microchannels are in fluid communication, but being otherwise as defined herein. In such embodiments, the SPM may be configured such that one or more microchannel(s), filter(s), sensor component(s), mixing chamber(s), metering chamber(s), eluent chamber(s), valve(s) and/or SPE(s) are redundant, not being in fluid communication with any RM microchannels, when the SPM is coupled to at least one of the two or more different analyte-specific RMs.

In a further aspect, the invention provides a system for the production and analysis of an analyte composition from a biological fluid sample, the system comprising the CMMD as defined above coupled to an analytical or detection device.

In another aspect, the invention provides a kit of parts comprising:
(a) two or more different, analyte-specific RMs, each comprising a different reagent but being otherwise as defined in any one of the preceding claims, and each RM being adapted for use in the preparation of a particular analyte composition from a biological fluid sample; and
(b) a universal SPM as defined in any one of the preceding claims, wherein the SPM microchannel is adapted to couple with the RM microchannel of any one of the two or more RMs, wherein any one of the two or more RMs may be coupled with the SPM to form a CMMD for producing a selected analyte composition from a biological fluid sample.

In another aspect, the invention provides a reagent module (RM) as defined herein and adapted for use in the device, system or kit of the invention.

In another aspect, the invention provides a sample processing module (SPM) as defined herein and adapted for use in the device, system or kit of the invention.

In another aspect, the invention provides a process for producing an analyte composition from a biological fluid sample comprising the steps of: (a) providing a biological fluid sample; (b) introducing said sample into the CMMD of the invention; and (c) collecting an analyte composition from the outlet of the CMMD.

In another aspect, the invention provides a method for detecting and/or quantifying an analyte derived from a biological fluid sample comprising the step of: (a) producing an analyte composition from a biological fluid sample according to the process of the invention; and (b) detecting and/or quantifying analyte in said analyte composition, optionally by LC-MS.

Other embodiments of the invention are as defined in the claims appended hereto.

### DETAILED DESCRIPTION

Microfluidic Devices

The reagent module and sample preparation module of the invention are modules of a microfluidic device. The term “microfluidic device” is a term of art referring to a device incorporating microchannels for the transport of liquids or gases.

In this context, the term “microchannel” as used herein refers to a fluid passage or plurality of fluid passages created within a suitable substrate, the passage having a capacity in the microlitre range. Microchannels can be used alone or in conjunction with other microchannels to form a network of channels with a plurality of flowpaths, manifolds, ports, reticulations and/or intersections.

The term “substrate” as used in the above context refers to the structural matrix used for fabrication of the microchannels using microfabrication techniques (including moulding, milling or carving) which are well-known in the art. A wide variety of substrate materials are commonly used for microfabrication including, but not limited to silicon, glass, polymers, plastics and ceramics. The substrate material may be partially or wholly transparent or opaque, dimensionally rigid, semi-rigid or flexible depending on the analyte and/or sample.

Generally, microfluidic devices comprise at least two substrate layers where one of the faces of the first substrate layer is provided with grooves and one face of the second substrate layer is overlaid onto the grooved face of the first layer to seal the grooves so generating a laminate containing microchannels at the laminate interface.

The modules may be formed of a biologically inert, stable plastic material that can be easily moulded, milled or carved. Moulding is preferred. Suitable plastics include acryl, polymethyl methacrylate, and a cyclic olefin copolymer. Polypropylene (or other polymers comprising units derived from propylene) is preferred.

The modular microfluidic device of the invention comprises:
(a) a reagent module (RM) comprising a reagent reservoir containing a reagent and an eluent reservoir containing an eluent, said reagent and eluent reservoirs being coupled to one or more RM microchannels; and
(b) a sample preparation module (SPM) comprising a SPM microchannel adapted to couple with the RM microchannel whereby fluid continuity between SPM and RM microchannels is produced on coupling, and:
   (i) a sample inlet for receiving said biological fluid sample; (ii) an outlet for delivering said analyte composition; (iii) a sensor component; (iv) a mixing chamber; (v) a metering chamber; (vi) an eluent chamber; (vii) a valve; and (viii) a solid phase extraction element (SPE).

The RM may comprise a plurality of coupled RM microchannels and reagent reservoirs, while the SPM may comprise a plurality of SPM microchannels.

In certain embodiments, each of the plurality of SPM microchannels is adapted to couple with one or more of the mixing, metering and/or eluent chambers. Alternatively, or in addition, each of the plurality of SPM microchannels is adapted: to couple with the valve and/or SPE and/or the sensor component and/or valve of the SPM and/or the metering chamber.

Fluid Level Sensor

In order to reliably and accurately aspirate an aliquot from a primary biological fluid sample and then load it into the microfluidic device in an automated fashion, the microfluidic device of the invention comprises a fluid level sensor. This permits automated detection of the level of the biological fluid in the sample vessel, and thereby the reliable aspiration and loading of the device even in cases where the sample is contained in a sealed and opaque sample vessel (such as a sealed Vacutainer® with applied barcode labels).

The fluid level sensor preferably comprises a pneumatic fluid level sensor operably coupled to an aspirator in fluid communication with the sample inlet of the SPM. Alternatively, the fluid level sensor comprises a sensor component adapted to form a pressure sensor in conjunction with an SPM pressure sensor component, wherein the sample inlet of the SPM is coupled to an aspirator for drawing a liquid aliquot from a biological sample contained in a sample vessel.

The fluid level sensor for use according to the invention may take any form provided that it is pneumatic or based on pressure sensing. This avoids problems associated with e.g. capacitive and conductive liquid level sensing systems (such as false level determinations caused by frothing).

Thus, in some embodiments, a source of compressed air (or any other gas, such as nitrogen) drives pulses of air past a very sensitive pressure transducer and through the aspirator. As the surface of the liquid sample is approached a slight back-pressure is developed in the aspirator tip which is sensed by the pressure transducer. In this way, the fluid surface level can be determined, the back pressure being a function of the volume and velocity of the air being pushed through the aspirator.

Determination of the surface level of the biological fluid permits automated movement of the aspirator into the biological sample a predetermined distance appropriate for the aliquot size to be aspirated without the need for manual manipulation/inspection of the aspirator and/or biological fluid sample.

Coupling of Reagent and Sample Preparation Modules

The microfluidic device of the invention is modular, comprised of interoperable reagent and sample preparation modules (RM and SPM, respectively). Thus, in the MMD of the invention, the RM and SPM are configured to be coupled together to yield the coupled modular microfluidic device (CMMD) of the invention, when they may function together to produce an analyte composition from a biological fluid sample.

The RM and SPM may be physically linked but not in fluid communication, for example by retaining means (for example detents, clips, catches, seals, registration holes or registration spigots on the RM and/or the SPM). In preferred embodiments, the retaining means provides a loose fit between RM and SPM prior to coupling.

Such physical linkage between RM and SPM prior to coupling may facilitate storage, transport and handling of the modular microfluidic devices of the invention, and may also facilitate registration and/or coupling of the RM and SPM when creating the CMMD (as described below).

In preferred embodiments, coupling of the RM and SPM modules is achieved by effecting fluid continuity between RM and SPM microchannels attendant on interfacing and mating the RM with the SPM.

Interfacing and mating may be achieved by the provision of one or more spike ports on the RM adapted to pierce one or more SPM microchannels whereby fluid continuity between SPM and RM microchannels is produced on coupling. Alternatively, or in addition, interfacing and mating of RM and SPM may be achieved by the provision of one or more spike ports on the SPM adapted to pierce one or more RM microchannels whereby fluid continuity between SPM and RM microchannels is produced on coupling.

The spike ports may pierce the RM and/or SPM microchannels at any location (referred to below as an “interface site”) suitable for achieving fluid continuity between RM and SPM. Typically, the interface site comprises a section of the microchannel which is enlarged and/or shaped to locate and receive (i.e. mate) with the spike port. In many embodiments, coupling of RM and SPM modules involves interfacing and mating at several different interface sites within the RM and/or SPM. Such features may facilitate the mechanical registration of RM and SPM modules during coupling.

The spike ports may take the form of short needles or cannulas, or stub tube ports. The spike ports may be adapted to pierce a septum covering the RM and/or SPM microchannel(s) at the interface site(s). In such embodiments, the septum may be a membrane, for example a polymeric or metal foil membrane.

Coupling of RM and SPM modules may be carried out manually, or by mechanical means. If carried out using mechanical means, the coupling is preferably automated (e.g. using robotics). The automated mechanical means may form part of a processing head (as herein described).

The coupling of RM and SPM modules may be facilitated by a physical linkage between non-coupled RM and SPM modules provided in certain embodiments, for example when a loose-fit mechanical linkage is provided.

Moreover, either or both of the RM and SPM may further comprise mechanical features which facilitate registration, interfacing and/or mating of the RM and SPM during coupling. For example, either or both of the RM and SPM may be configured with detents, clips, catches, seals, registration holes or registration spigots. When present, these mechanical features may form part of the physical linkage between RM and SPM described above.

When RM and SPM are coupled as described above, they form a coupled modular microfluidic device (CMMD) for producing an analyte composition from a biological fluid sample in which RM and SPM microchannels are in fluid communication.

Processing Head

The microfluidic devices of the invention produce an analyte composition from a biological fluid sample by a process which involves flow of various fluids (e.g. the analyte composition, reagents, eluents, biological sample, intermediate processing products, etc.) through the microchannels of the RM and SPM.

This flow of liquid may be driven by elements located on the RM and/or SPM itself, but in preferred embodiments fluid flow is driven by forces applied by a separate processing head. In such embodiments, the processing head is adapted to reversibly couple with one or more microchannels of the RM and/or SPM and to apply pumping or vacuum forces to liquid contained therein, so pushing (or drawing) liquid along the microchannels.

Thus, in preferred embodiments the microfluidic devices of the invention further comprise a processing head, said processing head comprising a pump adapted to couple with the RM microchannel for driving or aspirating fluid through said RM microchannel. Alternatively, or in addition, the processing head pump is further adapted to couple with the sample inlet and/or other microchannels of the SPM for drawing a liquid aliquot from a primary biological sample contained in a sample vessel (though this process may be effected manually, for example with a syringe).

The processing head may further comprises one or more sensor components and/or mixing actuating/control components. For example, the SPM sensor component may be adapted to form a sensor in conjunction with said processing head sensor component. The processing head sensor component may comprise a light source, a light sensor and/or a lens.

The processing head may also further comprise one or more valve actuators. These may take the form of valve head rotators, which interact with rotatable valve heads located in the RM and/or SPM to reconfigure the microchannel flow paths.

Coupling of the processing head to the RM and/or SPM microchannels may be effected by the provision of one or more couplings (e.g. spike ports, male-female couplings, O-ring sealing elements, etc.). The coupling is preferably a dry coupling, such that fluid continuity between the processing head and microchannels is produced on coupling so that air can be used to displace fluid in the RM and/or SPM microchannel(s). In preferred embodiments, the processing head is isolated from the liquids (including in particular the liquid sample and/or analyte compositions), for example by one or more air gaps.

Platforms

The devices of the invention may further comprise a platform comprising a carousel containing a plurality of the MMDs and a conveyer containing a plurality of vessels containing biological fluid samples.

The platform may further comprise: (a) means for coupling the RM and SPM modules to bring them into fluid communication and so form the CMMD of the invention; and/or (b) a processing head as described herein; and/or (c) means for automatically coupling an MMD or CMMD to a processing head as described herein; and/or (d) an incubation oven; and/or (e) a cooling element; and/or (f) a barcode reader; and/or (g) means for automatically removing an aliquot of sample from the sample vessels; and/or (h) a thermostat; and/or (i) one or more actuators.

The conveyor is adapted to bring successive individual sample vessels into registration with an individual MMD or CMMD.

In such embodiments, the carousel may be a drum carousel adapted to support and mechanically dispense a plurality of MMDs (for example, greater than 10, 50, 100, 200 or 300 MMDs).

The carousel may support and dispense MMDs in which the RM and SPM modules are physically linked but not in fluid communication (for example wherein the RM and SPM are physically linked by retaining means on the RM and/or the SPM, which retaining means may provide a loose fit between RM and SPM). In such embodiments, the platform may further comprise means (for example forming part of the processing head) for coupling the RM and SPM modules to bring them into fluid communication and so form the CMMD of the invention. Such means may comprise clamping or pressing means.

The various components of the devices of the invention (including inter alia the MMDs, CMMDs, RMs and/or SPMs), as well as the vessels containing biological fluid samples, may be barcoded, and in such embodiments the platform may comprise a barcode reader adapted to read the barcodes on the sample vessels and/or device components (e.g. the CMMDs).

The carousel may contain a plurality of MMDs each adapted for the preparation of a specific analyte (i.e. analyte-specific MMDs). Alternatively, the carousel may contain a mixture of different MMDs, each specific for a different analyte. In such embodiments, the platform may further comprise means for automatically selecting and removing an analyte-specific MMD, which means is controllable by input to a user interface (for example comprising a microprocessor and/or barcode reader).

Kits

The modular microfluidic devices of the invention may be comprised in a kit of parts comprising: (a) two or more different, analyte-specific RMs, each comprising a different reagent, and each RM being adapted for use in the preparation of a particular analyte composition from a biological fluid sample; and (b) a universal SPM wherein the SPM microchannel is adapted to couple with the RM microchannel of any one of the two or more analyte-specific RMs, wherein any one of the two or more RMs may be coupled with the SPM to form a CMMD for producing a selected analyte composition from a biological fluid sample.

Such kits provide great flexibility, allowing the provision of a large number of analyte-specific CMMDs all incorporating a single, generic (i.e. “universal”) SPM.

In such embodiments, interoperability of the universal SPM with a plurality of different RMs may be reflected in SPM redundancy. In this context, the term “redundancy” defines SPMs configured such that one or more:
(a) microchannel(s); and/or
(b) sensor component(s); and/or
(c) mixing chamber(s); and/or
(d) metering chamber(s); and/or
(e) eluent chamber(s); and/or
(f) valve(s); and/or
(g) filter(s); and/or
(g) SPE(s);
   are not in fluid communication with any RM microchannels when the SPM is coupled to at least one of the two or more different analyte-specific RMs provided in the kit.

The RM and SPM modules of the kits of the invention are otherwise as defined herein. Thus, for example, the sample inlet of the universal SPM may be coupled to an aspirator, wherein the aspirator is suitable for drawing an aliquot from a sample of blood (for example whole blood, lysed whole blood, plasma or serum) or urine.

In some embodiments, the universal SPM of the kit of the invention contains a plurality of SPEs, at least one of which is redundant and not in fluid communication with any RM microchannels when the SPM is coupled to at least one of the two or more different analyte-specific RMs.

Alternatively, or in addition, the universal SPM may contains a plurality of filters, at least one of which is redundant and not in fluid communication with any RM microchannels when the SPM is coupled to at least one of the two or more different analyte-specific RMs.

In the foregoing embodiments, said at least one redundant SPE and/or filter may be specifically adapted to process both blood (for example whole blood, lysed whole blood, plasma or serum) and urine.

Analytical Systems

The microfluidic devices of the invention may form part of an integrated system for the production and analysis of an analyte composition from a biological fluid sample.

Such systems may comprise the CMMD of the invention, wherein the RM is coupled to the SPM; a processing head as described above, coupled with the RM and/or SPM microchannel; a platform as described above; and an analytical or detection device, for example an LC-MS device, coupled to the CMMD outlet (for example by an injector) for detecting and/or quantifying an analyte composition prepared from a biological fluid sample by the device.

Aspirators

The CMMD of the invention comprises a sample inlet for receiving a biological fluid sample, and in preferred embodiments the sample inlet of the CMMD is coupled to an aspirator for drawing a liquid aliquot from a biological sample contained in a sample vessel.

The aspirator is preferably suitable for drawing an aliquot from a sample of blood (for example whole blood, lysed whole blood, plasma or serum) or urine.

Such embodiments find particular utility when the biological sample is a primary biological fluid sample (see section below headed “Biological samples”) contained in a sample vessel.

In such embodiments, the aspirator is preferably sufficiently rigid so as to be capable of piercing the (usually rubber or other flexible polymeric material) septum of a self-sealing biological sample vessel. Preferred aspirators are needles or cannulas, for example formed from glass, metal or hard plastic. Also suitable are aspirators which take the form of a pipette tip.

The CMMD and/or SPM may be integrated with the aspirator to form an autosampler suitable for use with automated mechanical (e.g. robotic) instrumentation. In such embodiments, the SPM-aspirator autosampler may be disposable, to be discarded by the operator after use.

Solid Phase Extraction Element (SPE)

The sample preparation module (SPM) of the invention comprises one or more solid phase extraction elements (SPEs). The SPE is preferably reversibly and selectively connectable to a plurality of microchannels via a plurality of ports and/or valves, so that sample at various stages of preparation may be loaded onto the SPE, the SPE washed and analyte eluted etc. via different microchannels.

Thus, in preferred embodiments the SPE comprises a valve for (selective) connection to: (a) a microchannel delivering a drying gas, for example air, to the SPE; and/or (b) the mixing chamber of the SPM; and/or (c) the eluent reservoir of the RM; and/or (d) the eluent chamber of the SPM. For example, the SPE may be provided with a rotatable valve head comprising a plurality of ports, which valve head may be rotated by a valve head rotator to reconfigure the microchannel flow path through the SPE by changing the position of the ports. In such embodiments, the valve head may be actuated by a valve head actuator located in a processing head as described above.

The physico-chemical nature and configuration of the SPE depends on the analyte to be prepared and the sample to be processed. A wide variety of SPE phases/chemistries are commercially available and can be integrated into a valve head in the SPMs of the invention. Thus, the SPE may comprise an open column, packed column or monolithic column. Also suitable are SPEs which comprise a functionalized monolithic sorbent. In such embodiments, the functionalized monolithic sorbent may comprise a polymerized monomer unit bearing: (a) a hydrophilic group or a precursor thereof; and/or (b) an ionizable group or a precursor thereof; and/or (c) an affinity ligand.

In some embodiments, the SPM contains a plurality of SPEs, at least one of which is redundant and not in fluid communication with any RM microchannels when the SPM is coupled to an RM. In such embodiments, redundancy is tolerated in the interests of efficiency savings associated with the ability to use a single universal SPM with a wide range of different analyte-specific RMs. Thus, such embodiments may be particularly useful in the analysis of multiple analytes from multiple types of liquid biological samples, and find particular application in the kits of the invention (see section headed “Kits”, below).

Embodiments comprises at least one redundant SPE may be specifically adapted to process both blood (including whole blood, lysed whole blood, serum and plasma) and urine.

Mixing Chambers

The sample preparation module (SPM) of the invention comprises one or more mixing chambers. These chambers define locations in which the sample, analyte or processing intermediates are mixed. Any form of mixing may be employed, according to the analyte to be prepared and the sample being processed. For example, passive diffusion of sample and reagent may effect mixing within one or more of the mixing chambers of the invention.

Alternatively, or in addition, mixing chambers may be provided in which mixing is effected actively. In such embodiments, the mixing chamber may contain an agitator, for example a bead or paddle. Such an agitator may be drivable by an external magnetic field, for example generated by a processing head as described in the section headed “Processing head” (below).

Metering Chambers

The sample preparation module (SPM) of the invention comprises one or more metering chambers. These may be volumetric or gravimetric, and/or may comprise features which function in conjunction with a sensor component to determine the volume of liquid contained in the metering chamber (or dispensed therefrom) and/or whether it is full. For example, the metering chamber may comprise a filling loop and may itself be transparent, or may be in close proximity to a downstream metering sensor, such as an optical sensor (e.g. working in conjunction with an external light source in a processing head) to actuate voiding/stop filling of the metering chamber when filled with a predetermined volume of liquid.

Filling and/or emptying of the metering chamber may be effected by a valve head actuator located in a processing head (as described above). For example, the metering chamber(s) may be provided with a rotatable valve head comprising a plurality of ports, which valve head may be rotated by a valve head rotator to reconfigure the microchannel flow path through the metering chamber by changing the position of the ports.

Filters

The sample preparation module (SPM) of the invention may comprise one or more filters. In certain embodiments, the SPM comprises a plurality of filters.

In embodiments where a plurality of filters is provided, the filters may be arranged in series such that fluid passes through a succession of successively finer filters.

The first filter in such a series may be a course filter adapted to remove debris such as precipitates or extraneous matter collected incidentally during sampling, and here the course filter may function as a course screen and have a very high molecular weight cut-off (e.g. greater than 300 kDa, greater than 1000 kDa or greater than 10,000 kDa).

Filters may be disposed at a common site of the SPM and provided as single unit (e.g. in the form of a “sandwich” of different filter components), or at different sites on the SPM and linked by microchannels.

The nature of the filter(s) depends on the analyte to be prepared and the sample to be processed. A wide variety of commercially available filter elements suitable for integration into LOC devices are commercially available.

The filter(s) may be specifically adapted to filter the biological fluid sample, for example a biological fluid is selected from: whole blood; lysed whole blood; serum; plasma; urine; sputum; sweat; follicular fluid; synovial fluid; amniotic fluid; a nasopharyngeal aspirate; a bronchial aspirate; semen and cerebrospinal fluid. Preferably, the filter(s) are adapted to filter both blood (including whole blood, lysed whole blood, serum or plasma) and urine but allowing the analyte and small molecular weight material to pass through.

The filters may functionally replace centrifugation in embodiments where the sample is lysed whole blood. In such embodiments, cellular debris produced on lysing the blood cells is removed by one or more filters without the need for a centrifugation step.

Alternatively, two or more filters may be provided each specifically adapted to filter two or more different biological fluid samples selected from: whole blood; lysed whole blood; serum; plasma; urine; sputum; sweat; follicular fluid; synovial fluid; amniotic fluid; a nasopharyngeal aspirate; a bronchial aspirate; semen and cerebrospinal fluid.

In certain embodiments, at least two filters are provided, a first filter adapted to filter whole blood or lysed whole blood, and a second filter adapted to filter urine.

Filters may also be adapted to separate non-cellular and cellular components of the biological fluid sample. For example, filters adapted to filter blood samples may have a molecular weight cut-off of 5-40 kDa (for example at least 5 kDa, at least 10 kDa, at least 20 kDa or at least 30 kDa). In some embodiments, at least one filter having a molecular weight cut-off of about 30 kDa is provided.

In other embodiments, the biological fluid sample is: (a) whole blood and said filter is adapted to separate cells and plasma; or (b) lysed whole blood and said filter is adapted to separate cellular debris and plasma.

The filters for use according to the invention which are adapted to filter blood, plasma or serum samples (including lysed whole blood samples) may comprises an anticoagulant for inhibiting clotting of filtered blood. Such filters may be formed from borosilicate, glass wool, Dacron, nylon or ceramic fibres.

In some embodiments, the SPM contains a plurality of filters. In such cases, the SPM may contain a plurality of filters, at least one of which is redundant. In this context, the filter may be redundant in that it is not in fluid communication with any RM microchannels when the SPM is coupled to an RM, or may be redundant in the sense that it does not selectively retain any components of the fluid passed through it. In such embodiments, redundancy is tolerated in the interests of efficiency savings associated with the ability to use a single universal SPM with a wide range of different analyte-specific RMs. Thus, such embodiments may be particularly useful in the analysis of multiple analytes from multiple types of liquid biological samples, and find particular application in the kits of the invention (see section headed “Kits”, below).

Embodiments comprising at least one redundant filter may be specifically adapted to process both blood (including whole blood, lysed whole blood, plasma and serum) and urine.

Thus, in certain embodiments the SPM comprises a first, course, filter having a molecular weight cut-off of greater than 300 kDa (e.g. greater than 1000 kDa or greater than 10,000 kDa) and a second filter having a molecular weight cut-off of up to 30 kDa. Here, the second filter may have a molecular weight cut-off of about 30 kDa.

Biological Samples

The invention finds application in the preparation of analyte compositions from any biological fluid, including (without limitation) whole blood, lysed whole blood, serum, plasma, urine, sputum, sweat, follicular fluid, synovial fluid, amniotic fluid, nasopharyngeal aspirates, bronchial aspirates, semen and cerebrospinal fluid. Preferred is whole blood, lysed whole blood, serum, plasma or urine.

In certain embodiments, the sample inlet of the SPM is coupled to an aspirator for drawing a liquid aliquot from a primary biological sample contained in a sample vessel. In this context, the term “primary biological sample” refers to a sample collected from a subject into a sample vessel or vial in unprocessed (or substantially unprocessed) form.

In some cases, a primary biological fluid sample is substantially unprocessed, but has been subjected to an initial, routine processing step. Thus, a plasma sample prepared by centrifugation of a whole blood sample is a primary biological fluid sample for the purposes of the invention, as is a whole blood sample which has been lysed and/or treated with anticoagulants. Similarly, a urine sample which has been treated with preservatives is also a primary biological fluid sample for the purposes of the invention. Other routine processing steps which may yield a primary biological sample for use according to the invention include simple dilution with a buffer, course filtration (to remove gross contaminants), removal of clotting factors (in the preparation of primary serum samples), thermal treatments (including freeze-thawing), sedimentation and centrifugation.

Thus, in some embodiments the biological fluid sample is a primary biological sample selected from whole blood, lysed whole blood, serum, plasma, urine, sputum, sweat, follicular fluid, synovial fluid, amniotic fluid, nasopharyngeal aspirates, bronchial aspirates, semen and cerebrospinal fluid.

In other embodiments, the biological fluid sample is a secondary biological sample. In this context, the term “secondary biological sample” refers to a sample derived from a primary biological sample (as defined above). The secondary sample may be derived from the primary sample by various means, including transfer of the primary sample into a different vessel, transfer of an aliquot into a different vessel, lyophilisation, pooling and labelling.

Alternatively, or in addition, the devices of the invention may be adapted for use with samples contained in commercially available blood-withdrawal vessels. Such vessels include the blood extraction container described in U.S. Pat. No. 4,449,539 and sold under the name MONOVETTE® (manufactured by Sarstedt). Other such vessels include the closed, evacuated tubes sold under the name VACUTAINER® (manufactured by Becton Dickinson).

Other Liquid Samples

As described above, the invention finds particular application in the preparation of analyte compositions from biological fluids, but those skilled in the art will appreciate that the devices of the invention may also be applied to other fluid sample, including (without limitation) environmental samples (e.g. river, sea, lake, spring or rainwater samples), sewage samples, water treatment samples, food samples and industrial effluent samples.

Reagents

The modular microfluidic device of the invention comprises a reagent module (RM) comprising a reagent reservoir containing a reagent.

The nature of the reagent depends on the analyte to be prepared. The reagent need not be reactive (in the sense of participating in a chemical transformation of one or more components of the biological sample). For example, in some embodiments the reagent contained in the RM reservoir functions to dry or condition the SPE (or elute analyte therefrom), and/or may serve simply as an inert carrier or solvent for one or more components of the sample or derived therefrom in the course of sample preparation (e.g. the analyte itself).

Thus, the reagent of the invention may be selected from one or more of the following: saline, water, air, a diluent, buffer, solvent (e.g. a polar solvent or non-polar solvent), emulsifying agent, wetting agent, surfactant, pH modifying agent (e.g. an acid or an alkali), lysing agent, detergent, carrier, dye, label, standard, marker, radioactive tracer, fluorescent tracer, eluent, an antibody, an enzyme, a nucleic acid, inert gas (e.g. air for drying the SPE) or SPE conditioner, washing agent or polarizing agent.

Preferred are RMs comprising a reagent reservoir containing a standard.

Typically, the RM comprises a plurality of reagent reservoirs each containing a different reagent. In many embodiments, the RM also comprises a plurality of reagent reservoirs each containing the same reagent, so facilitating delivery of the same reagent to the SPM via different flowpaths and to different destinations on the SPM at different stages of sample preparation.

In certain embodiments, the RM comprises a plurality of reagent reservoirs each containing a different reagent including: methanol, buffer, water and a methanol-water mixture.

The reagent contained in the RM reservoir is usually in the form of a liquid, but in some embodiments the reagent may be provided as a solid. Here, the reagent may take the form of a lyophilized powder or pellets and/or may be a phase-transition solid which is converted into a liquid state during sample preparation (when it may, for example, serve as a valve component—see below).

Analytes

The invention finds application in the preparation of an analyte composition from a sample of biological fluid. Preferred are analytes useful in the determination of a diagnosis or prognosis of a disease or injury, to determine nutritional or toxicological status, the response to therapeutic interventions or diet, to detect drug consumption, and to detect or monitor disease progression, pregnancy or fertility.

Any of a wide range of different analyte compositions may be prepared according to the invention, but preferred are compositions comprising analytes selected from: markers indicative of illness or malnutrition; markers indicative of drug abuse (for example selected from: alcohol, cocaine, marijuana, opiates, amphetamine, methamphetamine, amphetamines, phencyclidine, benzodiazepines, barbiturates, methadone, tricyclic antidepressants, heroin, steroids, niacin, xanax, vicodin, oxycontin, adderall, morphine and nicotine); markers indicative of pregnancy; markers indicative of fertility or infertility; markers indicative of cancer; markers indicative of metabolic disorders; markers indicative of medication (for example immunosuppressants, antimicrobial agents or chemotherapeutic agents); hormones; antibodies; antigens; enzymes (including for example alkaline phosphatase, alanine aminotransferase, aminotransferase, amylase, creatine kinase, gamma glutamyltransferase and lactate dehydrogenase); vitamins (including for example vitamin D), vitamin markers (including for example methylmalonic acid, a marker of vitamin B12), nucleic acids (for example DNA or RNA) and proteins (for example cytokines).

Other analytes include aspartate, albumin, blood urea nitrogen, calcium, cholesterol, chloride, creatinine, bilirubin, glucose, high-density lipoprotein cholesterol, low-density lipoprotein cholesterol, potassium, magnesium, phosphorus, sodium, carbon dioxide, triglycerides, uric acid and total protein.

The analyte may be an agent which is present in the primary biological fluid sample (in which case the analyte composition prepared according to the invention typically comprises the analyte in a purified, enriched or labelled form), or an agent which is not present in the primary biological fluid sample but prepared by physico-chemical derivatization of one or more components of the primary sample (for example, generated by reaction of one or more components of the primary sample with one or more of the reagents of the RM of the invention, or by thermal degradation).

In preferred embodiments, the analyte compositions prepared according to the invention are compositions in which the analyte is present in a physic-chemical milieu suitable (and in an amount sufficient) for analysis (e.g. quantification) by LC-MS.

Valves

The sample preparation module (SPM) of the invention comprises one or more valves for controlling fluid flow through the microchannels of the devices of the invention.

Various types of microfluidic valves can be used in the device of the invention. For example, the valves may be actuated by a threshold flow rate of the fluid. Examples of such passive valves include a capillary, siphon and hydrophobic valves.

Alternatively, or in addition, the valves may be active valves, actuated by a transmitted signal from an external source (for example, by electromagnetic radiation emitted from an external source, such as the processing head described infra).

Alternatively, or in addition, the valves may comprise a mechanically actuated valve member (i.e. a “valve head”). For example, the valve may comprise a rotatable valve head comprising a plurality of ports, which valve head may be rotated by a valve head rotator to reconfigure the microchannel flow path through the valve by changing the position of the ports. In such embodiments, the valve head may be actuated by a valve head actuator located in the processing head as described above.

The valve forming material may be a metal, metal alloy, composite, thermoplastic resin (for example polycarbonate, polystyrene, polyoxymethylene, perfluoralkoxy, polyvinylchloride, polypropylene, polyethylene terephthalate, polyetheretherketone, polyamide, polysulf one or polyvinylidene fluoride). The valve forming material can also be a phase transition material that exists in a solid state at room temperature. In such embodiments, the phase transition material is loaded when in a liquid state into channels, and then solidified to close the channels.

Sensors

The sample preparation module (SPM) of the invention comprises one or more sensor components. These sensor components need not constitute functional sensors per se, but may be adapted to form a functional sensor in conjunction with a processing head sensor component described above (in the section headed “Processing head”).

In some embodiments, the SPM sensor component comprises a pressure sensor component and/or an optical sensor component.

Preferred optical sensor components include optical sensor components which comprise an optical window. The optical window is optically transparent and may form a functioning sensor in conjunction with a processing head sensor component, which in such embodiments may comprise a light source, a light sensor and/or a lens.

In some embodiments, the SPM comprises a plurality of sensor components, for example comprising both an optical and a pressure sensor component.

Redundancy

The SPM of the various devices, systems and kits of the invention may be configured such that one or more microchannel(s), filter(s), sensor component(s), mixing chamber(s), metering chamber(s), eluent chamber(s), valve(s) and/or SPE(s) are redundant, not being in fluid communication with any RM microchannels, when the SPM is coupled to at least one of the two or more different analyte-specific RMs.

In such embodiments, redundancy is tolerated in the interests of efficiency savings associated with the ability to use a single universal SPM with a wide range of different analyte-specific RMs. Thus, the kits of the invention are particularly useful in the analysis of multiple analytes from multiple types of liquid biological samples.

Redundancy may also be tolerated at the level of the RM: in some embodiments RM comprises one or more empty chambers. This permits a single RM substrate configuration to be used for different analytes from different biological samples.

### EXEMPLIFICATION

Embodiments of the present invention will now be described by way of example with reference to the accompanying drawings in which:

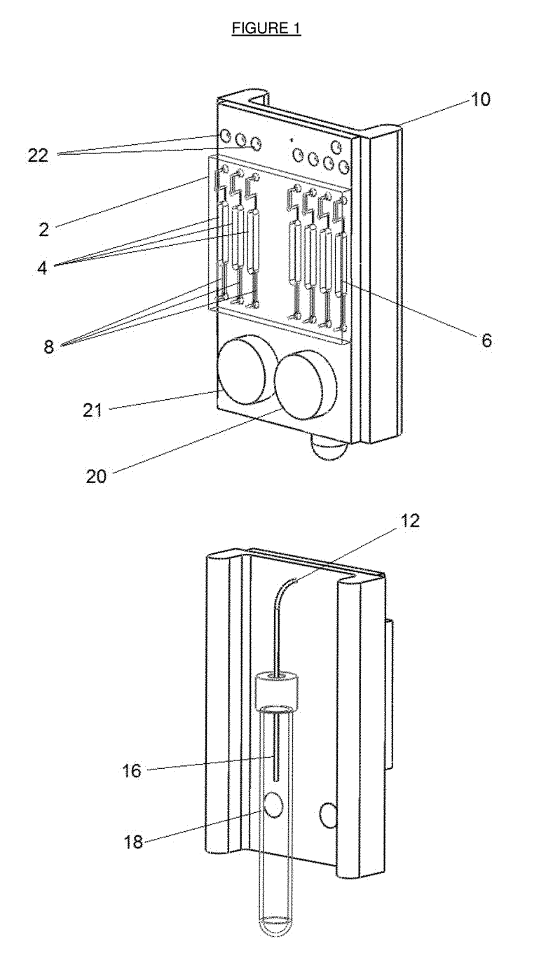

FIG. 1 shows a perspective view of an CMMD according to the invention.

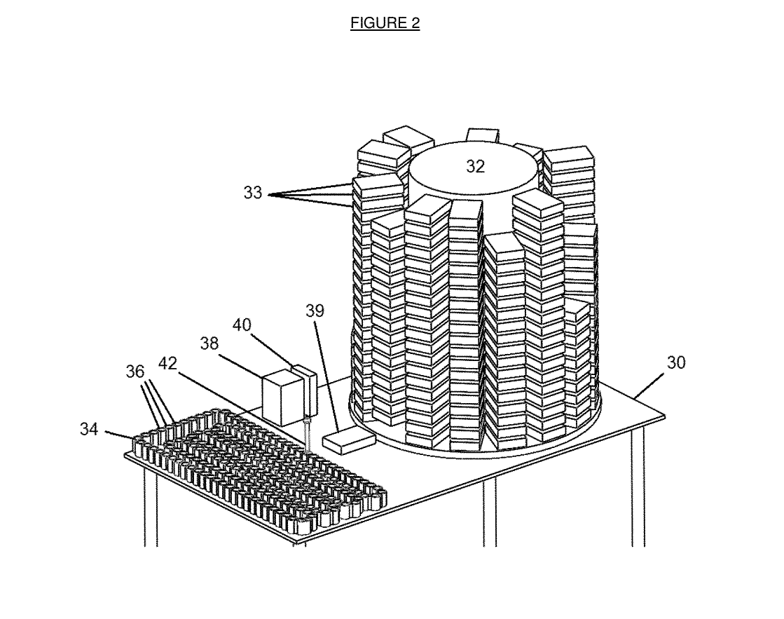

FIG. 2 illustrates schematically apparatus embodying the present invention.

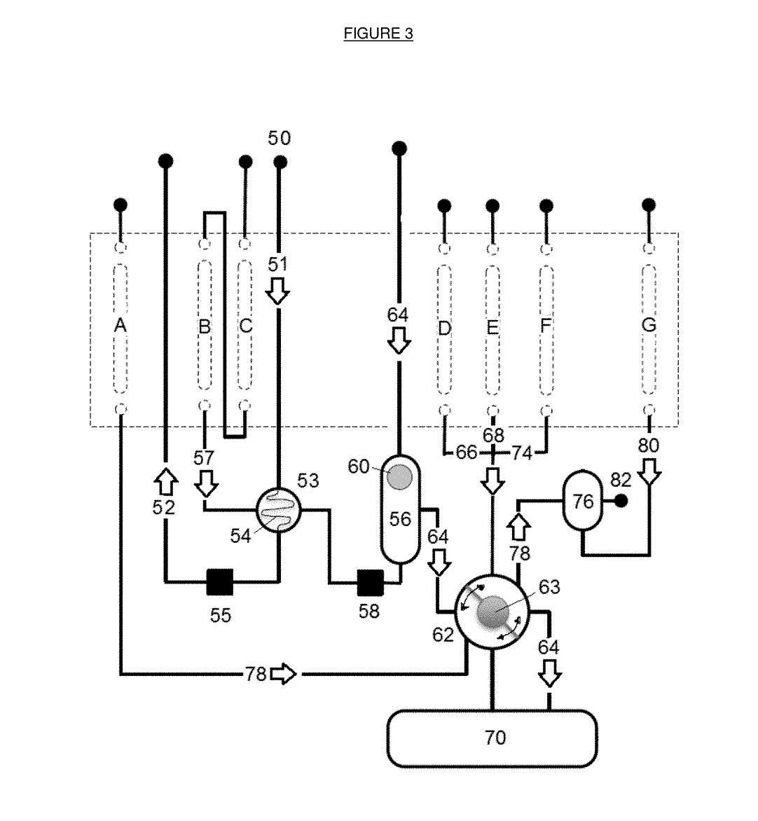

FIG. 3 schematically illustrates an CMMD of the invention.

### EXAMPLE 1: MICROFLUIDIC DEVICE

Referring now to FIG. 1, the CMMD comprises a reagent module (RM) 2 comprising several reagent reservoirs 4 each containing a reagent (not shown) and an eluent reservoir 6 containing an eluent (not shown), said reagent and eluent reservoirs being coupled to RM microchannels 8 and a sample preparation module (SPM) 10 comprising a SPM microchannel (not shown) coupled with the RM microchannel whereby fluid continuity between SPM and RM microchannels is established. The SPM has a sample inlet 12 connected to an aspirator 16 for receiving a biological fluid sample contained in a sample vessel 18, an outlet for delivering analyte composition, a sensor component, a mixing chamber, a metering chamber, an eluent chamber, a number of valves (not shown), a solid phase extraction elements (SPE) 20 and metering chamber valve head 21. The CMMD is provided with several interface sites 22 for coupling with a processing head (not shown).

### EXAMPLE 2: MICROFLUIDIC PLATFORM

Referring now to FIG. 2, the apparatus comprises a platform 30 comprising a drum carousel 32 containing a plurality of stacked MMDs 33 and a conveyer 34 containing a chain of vessels 36 each containing a biological sample. A processing head 38 is coupled with an MMD 39 loaded from the carousel by automated robot (not shown), during which the RM and SPM modules are themselves also coupled to form a CMMD 40, while an individual sample vessel 42 is brought into registration with an aspirator on the CMMD (not shown).

### EXAMPLE 3: VITAMIN D PREPARATION SEQUENCE

Referring now to FIG. 3, the dotted lines indicate the RM having seven reagent reservoirs A-G containing reagents as follows:
A: Methanol (100 μl)
B: Standard (40 μl)+methanol (500 μl)
C: Buffer (200 μl)
D: Methanol (100 μl)
E: Water (100 μl)
F: 70% methanol in water (100 μl)
G: Water (40 μl)

The aspirator (not shown) is pushed through the rubber septum of a sealed vessel containing a sample of serum (not shown). The aspirator is lowered towards the surface of the serum sample while pulses of air at low pressure air are driven through it. A pressure transducer (not shown) measures back pressure and thereby permits monitoring of the approach of the aspirator to the surface of the serum sample.

Once the surface of the serum sample is detected, pulsing of low pressure air through the aspirator is terminated and the aspirator tip further lowered a predetermined distance beneath the surface of the serum. 200 μl of serum is then drawn into sample inlet (50) along microchannel 51 into metering chamber 53 containing a filling loop 54 until determined to be full using sensor 55.

A valve head on the metering chamber (not shown) is then rotated by a rotating valve head actuator in a processing head (not shown) so that ports are aligned with microchannel 57. The serum is then pushed into the mixing chamber 56 along with the contents of reagent reservoirs B and C along microchannel 57 and their arrival and absence of entrained bubbles confirmed with sensor 58. The contents of the mixing chamber are then mixed with bead 60.

The SPE 63 with a two port rotating valve head 62 is then conditioned with: (a) the contents of reagent reservoir D along microchannel 66; then (b) the contents of reagent reservoir E along microchannel 68, the valve head 62 being rotated to bring the ports into alignment with the appropriate microchannels with a rotating valve head actuator in a processing head (not shown) with excess being collect in waste chamber 70.

500 μl of sample from the mixing chamber 56 is then loaded onto the SPE 63 along microchannel 64 with excess being collect in waste chamber 70. The SPE 63 is then washed with the contents of reservoir F along microchannel 74. SPE 63 is then dried with 250 μl of air.

The analyte is then eluted from the SPE 63 into eluent chamber 76 with the contents of reservoir A along microchannel 78. Polarization of the analyte composition in the eluent chamber 76 is then improved by adding the contents of reservoir G along microchannel 80. The polarized analyte composition is then injected into an LC-MS device (not shown) via outlet 82 for analysis.

### EQUIVALENTS

The foregoing description details presently preferred embodiments of the present invention which are therefore to be considered in all respects as illustrative and not restrictive. Those skilled in the art will recognize, or be able to ascertain, using no more than routine experimentation, many equivalents, modifications and variations to the specific embodiments of the invention described specifically herein. Such equivalents, modifications and variations are intended to be (or are) encompassed in the scope of the following claims.

1. A modular microfluidic device (MMD) for producing an analyte composition from a biological fluid sample, said device comprising:
(a) a reagent module (RM) comprising a reagent reservoir containing a reagent and an eluent reservoir containing an eluent, said reagent and eluent reservoirs being coupled to one or more RM microchannels; and
(b) a sample preparation module (SPM) comprising a SPM microchannel adapted to couple with the RM microchannel whereby fluid continuity between SPM and RM microchannels is produced on coupling, and:
(i) a sample inlet for receiving said biological fluid sample;
(ii) an outlet for delivering said analyte composition;
(iii) a mixing chamber;
(v) a metering chamber;
(vi) an eluent chamber;
(vii) a valve;
(viii) a solid phase extraction element (SPE); and
(ix) an aspirator in fluid communication with the sample inlet of the SPM for withdrawing an aliquot of said biological fluid when contained in a sample vessel, said aspirator being operably coupled to a pneumatic fluid level sensor.

2. The device of claim 1 wherein the SPM is directly or indirectly coupled to the aspirator, for example being indirectly coupled via a microchannel in the RM and/or a fluid passage in the processing head.

3. The device of claim 1 wherein the aspirator is rigid and suitable for piercing the septum of a self-sealing biological sample vessel, for example being a needle or cannula.

4. The device of claim 1 further comprising a processing head, said processing head comprising: (a) said pneumatic fluid level sensor; and (b) a gas supply/vacuum means adapted to couple with an MMD microchannel for driving or sucking fluid through said microchannel, said processing head pump being further adapted to couple with the sample inlet of the SPM for drawing a liquid aliquot from a primary biological sample contained in a sample vessel.

5. The device of claim 1 wherein said pneumatic fluid sensor comprises: (a) a two way gas supply/vacuum means connected to said aspirator and adapted to provide a low pressure air flow therethrough during movement of said aspirator toward said biological fluid when contained in a sample vessel; and (b) a pressure sensor adapted to detect a back pressure developed therein as said aspirator approaches the surface of said biological fluid.

6. The device of claim 5 wherein said pressure sensor is a pressure transducer.

7. The device of claim 1 wherein said gas supply/vacuum means comprises a source of compressed gas.

8. The device of claim 1 wherein said gas supply/vacuum means comprises a pump.

9. The device of claim 8 wherein said pump is a syringe pump.

10. The device of claim 1 wherein said two way gas supply/vacuum means is adapted to deliver pulsed low pressure air flow through the aspirator.

11. The device of claim 1 wherein said two way gas supply/vacuum means is adapted to deliver continuous low pressure air flow through the aspirator.

12. The device of claim 1 further comprising means for moving said aspirator toward and away from the surface of said biological fluid when contained in a sample vessel, optionally wherein the device further comprises means responsive to the fluid level being sensed for moving the aspirator into the biological sample a predetermined distance appropriate for the aliquot size to be aspirated.

13. A modular microfluidic device (MMD) for producing an analyte composition from a biological fluid sample, said device comprising:
(a) a reagent module (RM) comprising a reagent reservoir containing a reagent and an eluent reservoir containing an eluent, said reagent and eluent reservoirs being coupled to one or more RM microchannels; and
(b) a sample preparation module (SPM) comprising a SPM microchannel adapted to couple with the RM microchannel whereby fluid continuity between SPM and RM microchannels is produced on coupling, and:
(i) a sample inlet for receiving said biological fluid sample; (ii) an outlet for delivering said analyte composition; (iii) a pressure sensor component; (iv) a mixing chamber; (v) a metering chamber; (vi) an eluent chamber; (vii) a valve; and (viii) a solid phase extraction element (SPE); and.
(c) a processing head, said processing head comprising:
(i) a pump adapted to couple with an MMD microchannel for driving or aspirating fluid through said microchannel, said processing head pump being further adapted to couple with the sample inlet of the SPM for drawing a liquid aliquot from a primary biological sample contained in a sample vessel; and
(ii) a sensor component adapted to form a pressure sensor in conjunction with the SPM pressure sensor component;
wherein the sample inlet of the SPM is coupled to an aspirator for drawing a liquid aliquot from a biological sample contained in a sample vessel.

14. The device of claim 13 wherein said pressure sensor is a pneumatic fluid level sensor operably coupled to said aspirator, optionally wherein the device further comprises means responsive to the fluid level being sensed for moving the aspirator into the biological sample a predetermined distance appropriate for the aliquot size to be aspirated.

15. The device of claim 1 wherein the SPM is directly or indirectly coupled to the aspirator, for example being indirectly coupled via a microchannel in the RM and/or a fluid passage in the processing head.

16. The device of claim 1 wherein the aspirator is rigid and suitable for piercing the septum of a self-sealing biological sample vessel, for example being a needle or cannula.

17. The device of claim 1 wherein the RM and SPM are physically linked but not in fluid communication.

18. The device of claim 17 wherein the RM and SPM are physically linked by retaining means on the RM and/or the SPM.

19. The device of claim 18 wherein the retaining means provides a loose fit between RM and SPM.

20-68. (canceled)

69. A kit of parts comprising:
(a) two or more different, analyte-specific RMs, each comprising a different reagent but being otherwise as defined in any one of the preceding claims, and each RM being adapted for use in the preparation of a particular analyte composition from a biological fluid sample; and
(b) an SPM as defined in any one of the preceding claims, wherein the SPM is a universal SPM having a microchannel adapted to couple with the RM microchannel of any one of the two or more RMs, wherein any one of the two or more RMs may be coupled with the SPM to form a microfluidic device for producing a selected analyte composition from a biological fluid sample.

70-88. (canceled)
